(19) United States
(12) Patent Application Publication
(10) Pub. No.: US 2024/0400388 A1
(43) Pub. Date: Dec. 5, 2024

(54) PROCESS AIR COMPRESSION FOR AO PROCESS

(71) Applicant: Evonik Operations GmbH, Essen (DE)

(72) Inventors: Florian Lode, Schoeneck (DE); Hari Prasad Mangalapally, Hanau-Grossauheim (DE); Martin Wüller, Marl (DE); Eduardo Federico Arévalo Saade, Erlensee (DE)

(73) Assignee: Evonik Operations GmbH, Essen (DE)

(21) Appl. No.: 18/690,849

(22) PCT Filed: Sep. 6, 2022
(86) PCT No.: PCT/EP2022/074736

§ 371 Date: Mar. 11, 2024

(30) Foreign Application Priority Data
Sep. 13, 2021 (EP) 21196227.9

(51) Int. Cl. C01B 15/023

(52) U.S. Cl. CPC C01B 15/023

(57) ABSTRACT

A process for producing hydrogen peroxide with an oxidizing unit in an anthraquinone process can be performed. The process and oxidizing unit have a compressor for obtaining hot compressed oxygen containing gas. The hot compressed oxygen containing gas is utilized in a heat exchanger to increase the temperature of a compressed (cold) offgas obtained in an oxidizing step for the production hydrogen peroxide. Accordingly, the compressed and heated offgas can subjected to an expander without the formation of droplets or damaging the equipment. Moreover, the process and an oxidizing unit reduce the required amount of energy in the form of electrical power and steam, as well as the required amount of cooling medium in an anthraquinone process.

### TECHNICAL FIELD

The present invention relates to a process and an oxidizing unit for producing hydrogen peroxide in an anthraquinone process. The inventive process and oxidizing unit comprise a compressor for obtaining hot compressed oxygen containing gas. The hot compressed oxygen containing gas is utilized in a heat exchanger to increase the temperature of a compressed (cold) offgas obtained in an oxidizing step for the production hydrogen peroxide. Accordingly, the compressed and heated offgas can be subjected to an expander without the formation of droplets or damaging the equipment. Moreover, the process and an oxidizing unit reduce the required amount of energy in the form of electrical power and steam, as well as the required amount of cooling medium in an anthraquinone process.

### TECHNICAL BACKGROUND

The most used process for producing hydrogen peroxide on an industrial scale is the anthraquinone process (AO process), which generates hydrogen peroxide by hydrogenating a working solution of an alkylanthraquinone or an alkyltetrahydroanthraquinone in a water immiscible solvent and oxidizing the hydrogenated solution with oxygen (O₂) containing gas, usually with air. The hydrogen peroxide is then extracted with water from the oxidized working solution in an extraction column and the working solution is reused for generating hydrogen peroxide. Furthermore, the aqueous hydrogen peroxide solution can be concentrated in a distillation unit. An overview of the anthraquinone process is given in Ullmann's Encyclopedia of Industrial Chemistry, online edition, Vol. A 18, pages 397-409, DOI 0.1002/14356007.a13_443.pub2, and in particular in FIG. 5 on page 401.

The AO process consumes large amount of energy in the form of electrical power and steam for heating, as well as cooling medium. A substantial amount of energy is consumed by heating the compressed offgas obtained in the oxidation step.

During the oxidation of the hydrogenated solution with the compressed oxygen containing gas, oxygen is partly consumed and the compressed oxygen-depleted residual gas (the compressed offgas) is cooled (“cold compressed offgas”) to remove condensables prior to discharge back to the atmosphere via an adsorption unit for final contaminant removal. In order to discharge the compressed offgas or the cold compressed offgas, the pressure have to be reduced. The pressure of the compressed offgas is either reduced by throttling (i.e. without energy recovery) or via an expander (i.e. with energy recovery). With some condensables still present in the compressed offgas, the temperature drop in said expander can lead to droplet formation and even to freezing, which can damage the expander and also impact the offgas purification connected downstreams.

To prevent that problem, the temperature of the compressed offgas needs to be increased by steam heating in order to safely avoid temperatures close to or below the dew point/freezing point during the expansion process. Such steam heating represents a high energy consumption and is very costly.

The main electrical consumer of the AO process is the air compressor, which in turn is a large cooling medium consumer as heat must be removed from the oxygen containing gas when it is compressed to higher pressure levels required in the oxidation unit of the process. The pressure of the oxygen containing gas (compressed oxygen containing gas) needed for the oxidation should be 3 to 5 bar (zero-referenced against a perfect vacuum). Substantial amounts of energy are thus disposed via e.g. cooling towers without further usage.

Accordingly, a process as well as an oxidizing unit for an AO process should be provided that reduces the required amount of energy in the form of electrical power and steam, as well as cooling medium.

U.S. Pat. No. 4,485,084 discloses a process for recovering solvent from an offgas in an AO process. It is desired that the offgas is expanded so that the offgas is cooled below the dewpoint of the solvent to thereby recover the solvent. U.S. Pat. No. 4,485,084 suggests cooling or heating the offgas prior to expansion so that the resulting temperature after the expansion is 10° C. or below. The temperature can be increased to permit maximum recovery of mechanical energy from the expansion step. The energy for heating the offgas can be supplied from waste heat sources. However, it is not suggested to increase the temperature of the compressed offgas prior to the expansion step by using the hot and compressed oxygen containing gas that is used for the oxidation step. Particularly, heating the offgas with the hot compressed oxygen containing gas prevents the formation of droplets in an expander since the hot compressed offgas is able to provide enough energy so that the temperature of the offgas is above the dew point of the solvents present in the compressed offgas. Accordingly, U.S. Pat. No. 4,485,084 teaches away from the present invention. Moreover, since hot compressed oxygen containing gas subjected to the oxidation is always available in a constant ratio for heating the (cold) compressed offgas derived from said hot compressed oxygen containing gas, a continuous and versatile process is obtained.

Accordingly, Thus, it is now found in this invention that the hot compressed oxygen containing gas can be utilized as a heat source for increasing the temperature of the compressed (cold) offgas to the intended level prior to entering the expander. For this, the hot compressed oxygen containing gas and the compressed (cold) offgas are fed to a heat exchanger, with the hot compressed oxygen containing gas decreasing as the temperature of the compressed (cold) offgas is increasing. This heat exchange substantially reduces both the required steam input for heating the compressed (cold) offgas, i.e. improves energy efficiency, and the required cooling water quantity for cooling the hot compressed oxygen containing gas. As a result, energy can be recovered from the compressed (cold) offgas via an expander at improved energy efficiency and safely avoiding the risk of expander damage from droplets or frozen crystals. In addition, operational flexibility is intrinsically granted due to compressed (cold) offgas always being available at the same time as hot compressed oxygen containing gas. Additionally, the method does not negatively affect the production of hydrogen peroxide in an AO process.

### SUMMARY OF THE INVENTION

Particularly, the aforementioned objective can be achieved by a process (200) (FIG. 2) for oxidizing a hydrogenated working solution (110), comprising alkylanthrahydroquinone, and/or alkyltetrahydroanthrahydroquinone, in an anthraquinone process for producing hydrogen peroxide, preferably carried out in a oxidizing unit (100a-d) (FIG. 1) or a facility according to the invention, comprising the steps: (a) providing a compressed oxygen containing gas (143, 145, 146) obtained after the following steps, comprising: (I) compressing (211) a first oxygen containing gas (126), such as air or enriched oxygen containing air, in a first compressor (120) and thereby increasing the pressure and temperature to obtain a first hot compressed oxygen containing gas (142), such as a first hot compressed air or a first hot compressed enriched oxygen containing air, and (II) subjecting (212) the first hot compressed oxygen containing gas (142) obtained in step (a)(I) to a first heat exchanger (150), to thereby reduce the temperature to obtain a first compressed oxygen containing gas (143), such as a first compressed air or a first compressed enriched oxygen containing air, (b) oxidizing (213) a hydrogenated working solution (110), comprising alkylanthrahydroquinone, and alkyltetrahydroanthrahydroquinone, with the compressed oxygen containing gas (143, 145, 146) obtained in step (a) to thereby obtain an oxidized working solution (112), comprising hydrogen peroxide and alkylanthraquinone, and/or alkyltetrahydroanthraquinone, and compressed offgas (148) derived from the compressed oxygen containing gas (143, 145, 146), and (c) providing (216) offgas (154b, 155b) obtained after the following steps, comprising: (I) subjecting (214) the compressed offgas (148) obtained in step (b) to the heat exchanger (150) mentioned in step (a)(II), that is subjected with the first hot compressed oxygen containing gas (142), to thereby obtain a first hot compressed offgas (154a), and (II) expanding (215) the first hot compressed offgas (154a) in a first expander (152) and thereby reducing the pressure and temperature to obtain a first offgas (154b).

The aforementioned oxidizing process (200) is also used in a process for making hydrogen peroxide, preferably carried out in a oxidizing unit (100a-d) or a facility according to the invention, comprising the steps: (a) hydrogenating a working solution, said working solution comprising an alkylanthraquinone, an alkyltetrahydroanthraquinone or both, contact said working solution, with compressed hydrogen in a hydrogenator to provide a hydrogenated working solution comprising an alkylanthrahydroquinone, an alkyltetrahydroanthrahydroquinone or both, (b) oxidizing said hydrogenated working solution obtained in step a) according to the inventive process to provide an oxidized working solution comprising hydrogen peroxide and an alkylanthraquinone, an alkyltetrahydroanthraquinone or both, (c) extracting hydrogen peroxide from oxidized working solution (112) obtained in step b) to provide an aqueous hydrogen peroxide extract, and (d) concentrating the aqueous hydrogen peroxide extract obtained in step c) in at least one distillation unit comprising an evaporator and a distillation column, said distillation column receiving vapor from said evaporator, to provide a concentrated aqueous hydrogen peroxide solution.

The present invention also concerns an oxidizing unit (100a-d) for oxidizing a hydrogenated working solution (110), comprising alkylanthrahydroquinone, and/or alkyltetrahydroanthrahydroquinone, in an anthraquinone process for producing hydrogen peroxide, preferably using the process according to the invention, comprising: (a) a first compressor (120) for increasing the pressure and the temperature of a first oxygen containing gas (126), such as air or enriched oxygen containing air, to obtain a first hot compressed oxygen containing gas (142), such as a first hot compressed air or a first hot compressed enriched oxygen containing air, (b) a first heat exchanger (150) (A) for reducing the temperature of the first hot compressed oxygen containing gas (142), such as a first hot compressed air or a first hot compressed enriched oxygen containing air, to obtain a first compressed oxygen containing gas (143), such as a first compressed air or a first compressed enriched oxygen containing air, and (B) for increasing the temperature of compressed offgas (148) to obtain a first hot compressed offgas (154a), (c) an oxidizer (111) for oxidizing a hydrogenated working solution (110), comprising alkylanthrahydroquinone, and/or alkyltetrahydroanthrahydroquinone with the compressed oxygen containing gas (143, 145, 146), such as the first compressed oxygen containing gas (143) or the second compressed oxygen containing gas (145), to thereby obtain an oxidized working solution (112), comprising hydrogen peroxide and alkylanthraquinone, and/or alkyltetrahydroanthraquinone, and compressed offgas (148) derived from the compressed oxygen containing gas (143, 145, 146), and (d) a first expander (152) for expanding the first hot compressed offgas (154a) provided by the first heat exchanger (150) to obtain a first offgas (154b).

The aforementioned oxidizing unit (100a-d) is also used in a facility for producing a concentrated hydrogen peroxide solution by an anthraquinone process, preferably using a process according to the invention, comprising: (a) a hydrogenator for hydrogenating the working solution, to provide a hydrogenated working solution, (b) an oxidizer (111), in an oxidizing unit (100a-d) according to the invention, for oxidizing the hydrogenated working solution with the compressed oxygen containing gas (143, 145, 146) to provide an oxidized working solution (112) comprising hydrogen peroxide, (c) a liquid-liquid extraction column for extracting the oxidized working solution (112) comprising hydrogen peroxide to provide aqueous hydrogen peroxide, and (d) a distillation unit for concentrating the aqueous hydrogen peroxide to provide a concentrated hydrogen peroxide solution.

Additionally, the present invention is directed to the use of at least one heat exchanger (150, 151) in an anthraquinone process or facility for producing hydrogen peroxide for increasing the temperature of a compressed offgas (148) and for decreasing the temperature of a first and/or second hot compressed oxygen containing gas (142, 144). Moreover, at least one expander (152, 153) is used in an anthraquinone process or facility for producing hydrogen peroxide for a first and/or second hot compressed offgas (154a, 155a) to drive at least one compressor (120, 128) for a first, second oxygen containing gas (126, 127), and/or a first compressed oxygen containing gas (143). It is particularly preferred that the at least one expander used for a first and/or second hot compressed offgas (154a, 155a) is an expander turbine.

These and other optional features and advantages of the present invention are described in more detail in the following description, aspects and figures.

### BRIEF DESCRIPTION OF THE DRAWINGS

FIG. 1 (FIG. 1a) shows an oxidizing unit (100a) for oxidizing a hydrogenated working solution (110).

FIG. 1 (FIG. 1b) shows an oxidizing unit (100b) for oxidizing a hydrogenated working solution (110) comprising a first expander (152).

FIG. 1 (FIG. 1c) shows an oxidizing unit (100c) for oxidizing a hydrogenated working solution (110) comprising a first expander as well as a parallel expander (152b) and a three-stage compressing system.

FIG. 1 (FIG. 1d) shows an oxidizing unit (100d) for oxidizing a hydrogenated working solution (110) comprising a further compressor (170) connected to the first expander (152).

FIG. 2 (FIG. 2) shows a process for oxidizing a hydrogenated working solution (110) comprising a first heat exchanger (150) and a first expander (152).

FIG. 3 (FIG. 3) shows a process for oxidizing a hydrogenated working solution (110) comprising a first and second heat exchanger (150, 151) and a first and second expander (152, 153).

FIG. 4 (FIG. 4) shows a process for oxidizing a hydrogenated working solution (110) comprising a first and second heat exchanger (150, 151), a first and second expander (152, 153), and a first and second compressor (120, 128).

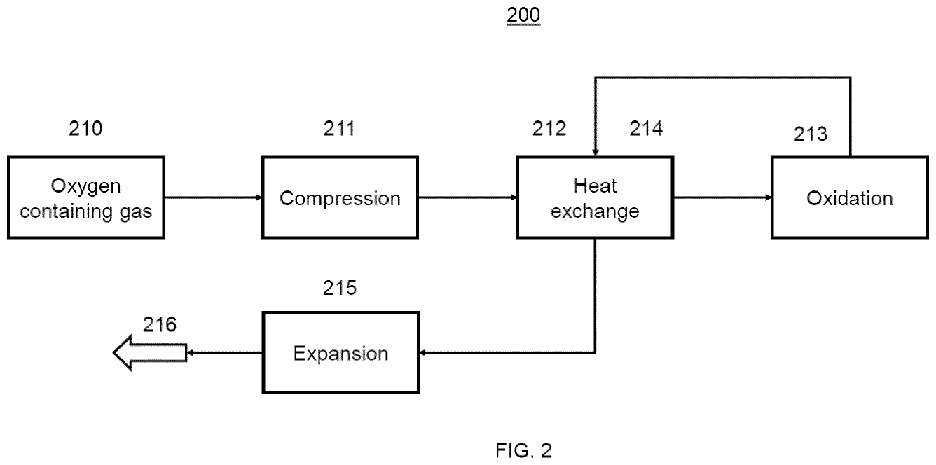

FIG. 2 (FIG. 5) shows a process for oxidizing a hydrogenated working solution (110) comprising a first heat exchanger (150), a first expander (152) and a parallel expander (152b).

### DETAILED DESCRIPTION

As used in the specification and the appended claims and aspects, the singular forms “a,” “an” and “the” include plural referents unless the context clearly dictates otherwise. The present invention is described with reference to the accompanying figure, which do not limit the scope and ambit of the invention.

Hydrogen peroxide can be produced in an AO process as described above. Generally, the AO process comprises the following steps. Hydrogenating a working solution, said working solution comprising an alkylanthraquinone, an alkyltetrahydroanthraquinone or both, contacting said working solution with compressed hydrogen in a hydrogenator to provide a hydrogenated working solution comprising an alkylanthrahydroquinone, an alkyltetrahydroanthrahydroquinone or both, oxidizing said hydrogenated working solution with compressed oxygen containing gas, such as compressed air or compressed enriched oxygen containing air, in an oxidizer to provide an oxidized working solution comprising hydrogen peroxide and an alkylanthraquinone, an alkyltetrahydroanthraquinone or both, extracting hydrogen peroxide from the oxidized working solution to provide an aqueous hydrogen peroxide solution, and concentrating the aqueous hydrogen peroxide solution in at least one distillation unit.

The inventive process according to the invention for oxidizing a hydrogenated working solution, comprising alkylanthrahydroquinone, and/or alkyltetrahydroanthrahydroquinone, in an anthraquinone process for producing hydrogen peroxide, comprises the following steps: (a) providing a compressed oxygen containing gas obtained after the following steps, preferably the compressed oxygen containing gas is the first, second compressed oxygen containing gas, or the second hot compressed oxygen containing gas, comprising: (I) compressing a first oxygen containing gas, such as air or enriched oxygen containing air, in a first compressor and thereby increasing the pressure and temperature to obtain a first hot compressed oxygen containing gas, such as a first hot compressed air or a first hot compressed enriched oxygen containing air, and (II) subjecting the first hot compressed oxygen containing gas obtained in step (a)(I) to a first heat exchanger, to thereby reduce the temperature to obtain a first compressed oxygen containing gas, such as a first compressed air or a first compressed enriched oxygen containing air, (b) oxidizing a hydrogenated working solution, comprising alkylanthrahydroquinone, and alkyltetrahydroanthrahydroquinone, with the compressed oxygen containing gas obtained in step (a) to thereby obtain an oxidized working solution, comprising hydrogen peroxide and alkylanthraquinone, and/or alkyltetrahydroanthraquinone, and compressed offgas derived from the compressed oxygen containing gas, and (c) providing offgas obtained after the following steps, preferably the offgas is the first, or second offgas, comprising: (I) subjecting the compressed offgas obtained in step (b) to the heat exchanger mentioned in step (a)(II), that is subjected with the first hot compressed oxygen containing gas, to thereby obtain a first hot compressed offgas, and (II) expanding the first hot compressed offgas in a first expander and thereby reducing the pressure and temperature to obtain a first offgas.

Accordingly, the inventive process relates to the oxidation step in an AO process, wherein the required oxygen (molecular oxygen, O₂) is provided as compressed oxygen containing gas. It is particularly preferred that the oxygen containing gas is air. However, it is also possible to use enriched oxygen containing gas or enriched oxygen containing air (i.e. air that is enriched with oxygen). If air is used as the oxygen containing gas, it will be evident that the gases mentioned in the following steps are also derived from said air. Accordingly, compressing air results in hot compressed air and said hot compressed air can be subjected to a heat exchanger resulting in compressed air that is used in the oxidizer.

In the first step (a) for oxidizing a hydrogenated working solution, a compressed oxygen containing gas is provided. The compressed oxygen containing gas is obtained after the compression of the oxygen containing gas and after subjection to at least one heat exchanger. It is desired that the compression and the heat exchange can be done multiply times. It is particularly desired that two heat exchangers are present in series so that the temperature of the hot compressed oxygen containing gas is successively reduced. The compressed oxygen containing gas mentioned in step (a) is the compressed oxygen containing gas after the compression and heating steps. For instance, the oxygen containing gas can be subjected in the following order to a first compressor, a first heat exchanger, a second compressor and then, to a second heat exchanger. However, a third compressor and/or a third heat exchanger can also be present. Each of the used compressors may have several compression steps, e.g. 2 to 4. It is evident that further components, such as valves, measurement equipment, heating/cooling devices etc., can be present between the compressors and heat exchangers. Preferably, the compressed oxygen containing gas is the first, second compressed oxygen containing gas, or the second hot compressed oxygen containing gas. However, it is desired that the compressed oxygen containing gas is the gas obtained in the last sub-step of step (a).

Step (a) comprises at least two sub-steps, namely (I) and (II) (step (a)(I) and step (a)(II)). First, a first oxygen containing gas, such as air or enriched oxygen containing air, is compressed (I) in a first compressor and thereby increasing the pressure and temperature to obtain a first hot compressed oxygen containing gas, such as a first hot compressed air or a first hot compressed enriched oxygen containing air. In the second step the first hot compressed oxygen containing gas obtained in step (a)(I) is subjected (II) to a first heat exchanger, to thereby reduce the temperature to obtain a first compressed oxygen containing gas, such as a first compressed air or a first compressed enriched oxygen containing air. In this case, the compressed oxygen containing gas is the first compressed oxygen containing gas. However, as mentioned above, it is possible that the first compressed oxygen containing gas is subjected to another compressor and/or heat exchanger so that the obtained gas after the subjected to said another compressor and/or heat exchanger will be the compressed oxygen containing gas.

After step (a) a hydrogenated working solution, comprising alkylanthrahydroquinone, and alkyltetrahydroanthrahydroquinone, is oxidized (b) with the compressed oxygen containing gas obtained in step (a) to thereby obtain an oxidized working solution, comprising hydrogen peroxide and alkylanthraquinone, and/or alkyltetrahydroanthraquinone, and compressed offgas derived from the compressed oxygen containing gas. Thus, the inventive process provides a compressed (cold) oxygen containing gas for the oxidation of the hydrogenated working solution. For the oxidation it is beneficial that the provided oxygen (O₂) has a low temperature and high pressure to accelerate the oxidation. This can be achieved by the compression of the oxygen containing gas and the reduction of the temperature of the hot compressed oxygen containing gas. Using a heat exchanger instead of a cooling tower significantly reduce the amount of energy required for cooling means and avoids the usage of a cooling medium that must be exposed to the environment.

The oxidation is preferably carried out in an oxidizer. The oxidized working solution, comprising hydrogen peroxide and alkylanthraquinone, and/or alkyltetrahydroanthraquinone can be subjected to an extraction and distillation step to thereby obtain hydrogen peroxide.

After step (b) offgas is provided (c) that is obtained after at least steps (I) and (II) (i.e. (c)(I) and (c)(II)). Similar to step (a), the offgas is the offgas obtained after the last sub-step (e.g. (II), (II) or (IV)), or the last reduction of the temperature and/or expansion. In step (c)(I) the compressed offgas obtained in step (b) is subjected to the heat exchanger mentioned in step (a)(II), that is subjected with the first hot compressed oxygen containing gas, to thereby obtain a first hot compressed offgas. Said first hot compressed offgas is expanded (c)(II) in a first expander and thereby reducing the pressure and temperature to obtain a first offgas. It is desired that the step further includes the subjection to a second expander and/or a second heat exchanger. If further heat exchanger are used, the compressed (hot) oxygen containing gas is utilized to increase the temperature of the compressed offgas. The compressed offgas can be subjected in the following order to a first heat exchanger, a first expander, a second heat exchanger and a second expander. Moreover, a third heat exchanger and a third expander can also be implemented. Further components, such as valves, measurement equipment, heating/cooling devices etc., can be present between the heat exchangers and expanders. Preferably the offgas is the first, or second offgas. However, it is desired that the offgas is the offgas obtained in the last sub-step of step (c).

The combination of heating the compressed (cold) offgas and cooling the hot compressed oxygen containing gas in a heat exchanger is particularly useful since compressed (cold) offgas always being available at the same time as hot compressed oxygen containing gas in an AO process. Moreover, using the process according to the invention can scientifically reduce the required amount of energy needed for heating and cooling the compressed offgas and the compressed (hot) oxygen containing gas, respectively. Moreover, no cooling medium is need or exposed to the environment for reducing the temperature of the compressed (hot) oxygen containing gas.

The process can further include step (a)(II) after step (a)(II), wherein the first compressed oxygen containing gas obtained in step (a)(II) is compressed in a second compressor, and thereby increasing the pressure and temperature to obtain a second hot compressed oxygen containing gas, such as a second hot compressed air or a second hot compressed enriched oxygen containing air. Accordingly, the compression of the oxygen containing gas can be done in two stages, wherein the heat is exchanged between the two compression steps. This is particularly preferable since the heat that is subjected to the compressed offgas can be regulated by adjusting the pressure in the first compressor, wherein the second compressor can be used to provide a compressed oxygen containing gas having the desired pressure for the oxidation step.

Moreover, the inventive process can also comprise a second heat exchanger that is arranged subsequent and downstream with respect to the compressed oxygen containing gas and the first heat exchanger. The second heat exchanger can be arranged downstream and subsequent to the first expander with respect to the offgas. If a second heat exchanger is present, the compressed oxygen containing gas or the second hot compressed oxygen containing gas will heat the first offgas. Thus step (a) can further includes (A) step (IV) after step (II) and optionally after step (II), subjecting the first compressed oxygen containing gas, obtained in step (a)(II), or the second hot compressed oxygen containing gas obtained in step (a)(II) to a second heat exchanger, to thereby reduce the temperature to obtain a second compressed oxygen containing gas, such as a second compressed air or a second compressed enriched oxygen containing air, and (B) wherein step (c) further includes step (II) after step (II), subjecting the first offgas obtained in step (c)(II) to the second heat exchanger mentioned in step (a)(IV), to thereby obtain a second hot compressed offgas.

Is particularly preferred that the present invention comprises a second compressor as well as a second heat exchanger as described above.

A second expander can also be present so that the pressure of the compressed offgas is successively reduces. This further avoids the formation of droplets and damage to the expansion equipment. Thus, step (c) can further include step (IV) after step (II) and optionally after step (II), expanding the first offgas obtained in step (c)(II), or the second hot compressed offgas obtained in step (c)(II), in a second expander and thereby reducing the pressure and temperature to obtain a second offgas. Is particularly preferred that the present invention comprises a second compressor, a second heat exchanger as well as a second expander as described above.

It is further desired that a parallel expander is used. Accordingly, the compressed offgas is first subjected to the heat exchanger and then to a first expander as well as a parallel expander.

The first compressor is used to compress a first oxygen containing gas, however a second oxygen containing gas can be provided in a parallel process that is compressed using a parallel compressor. In other words, two oxygen containing gas streams can be provided and each oxygen containing gas stream is compressed with a different compressor, i.e. the first and the parallel compressor. The obtained hot compressed oxygen containing gas of both compressors is then utilized in the first heat exchanger. Thus, step (a)(I) further includes that a second oxygen containing gas, such as air or enriched oxygen containing air, is compressed in a parallel compressor and thereby increasing the pressure and temperature to obtain a first hot compressed oxygen containing gas, such as a first hot compressed air or a first hot compressed enriched oxygen containing air, wherein the first hot compressed oxygen containing gas obtained from the first and parallel compressor is subjected to the first heat exchanger according to step (a)(II). A parallel compressor can be used in order to provide a constant high flow of hot compressed oxygen containing gas to the first heat exchanger.

Moreover, the first as well as the parallel compressor can each comprise at least two compressors that are connected in series so that the pressure increases successively. If a high amount of compressed gas is needed, the compression can be done in series before subjecting the compressed products to the first heat exchanger. Preferably a cooling unit is arranged between the compressors arranged in series. Said cooling unit can be used if the temperature increase is too high by using only one compressor. A very high temperature, such as 200° C. can damage a compressor. The cooling unit reduces the temperature to a suitable amount so that the required pressure of e.g. 3.5 bar can be achieved without damaging the compressor.

The oxygen containing gas, such as the first and second oxygen containing gas, can be filtered using a filter unit that is arranged in front of the first compressor and/or the second compressor so that the first and/or second oxygen containing gas, such as air or enriched oxygen containing air, is filtered before the compression. Oxygen containing gas sometimes comprises impurities that negatively affect the production of hydrogen peroxide in an oxidation unit so that filtering is preferred.

The expander for decreasing the temperature and pressure of the compressed (hot) offgas can be used to drive compressors in an AO process. A compressor for increasing the pressure of a gas consumes a lot of energy such as electrical energy so that driving the compressor by using the expander results in a lesser consumption of energy. Thus, the first expander can drive the first compressor, preferably drive at least one rotating equipment connected with the compressor. Moreover, the second expander can drive the second compressor, preferably drives at least one rotating equipment connected with the second compressor. It is desired that the expander is an expander turbine that drives the aforementioned compressors.

A bypass conduit can be arranged in an oxidizing unit so that compressed offgas can bypass the first heat exchanger as well as the first expander, and/or the second heat exchanger and the second expander. That allows individual manipulation of the corresponding flow rates of the offgas. Ideally, the valve to the expander is fully open, maximizing energy recovery. Pressure fluctuations are compensated by modulating the comparably small bypass stream. In case of the expander being shut-down, the full offgas flow is bypassing it and is being modulated with a control valve. It is preferred that a portion, such as 1 to 60%, preferably 5 to 40%, more preferably 10 to 30%, and most preferably 15 to 30% bypasses the first heat exchanger as well as the first expander and preferably bypasses the first heat exchanger, the first expander, the second heat exchanger and the second expander.

Additionally, a bypass for the (first) hot compressed oxygen containing gas can be present so that said gas can bypass the first and second heat exchanger. Thus, the temperature at each expander inlet can be controlled by modulating the amount of air bypassing the heat exchangers. As a result, the temperature of the compressed oxygen containing gas to oxidation will be constant at all times.

After step (c), the process can include that the offgas is further heated or cooled in a heating unit or cooling unit, respectively. This allows a precise control of the temperature of the gas flow. The precise control is particularly desired if the gas flow is subjected to a filtering unit comprising activated carbon.

The filtering of the offgas can occur after step (c) and preferably after the subjection to the heating/cooling unit. The filtering unit can comprise an activated carbon filter. Thus, impurities can be filtered so that the offgas can be subjected to the environment.

The compressed oxygen containing gas obtained in step (a) can be cooled in a cooling unit before used for oxidation according to step (b). Similarly, the compressed offgas obtained in step (b) can be cooled in a cooling unit.

The compressed offgas obtained in step (b) can be subjected to a chilled water heat exchanger, a first droplet separator and/or a second droplet separator. Preferably the offgas is subjected in the following order to a cooling unit, a chilled water heat exchanger, a first droplet separator a second droplet separator. It is beneficial that no droplet formation occurs in an expander since droplets can damage the expander device.

As mentioned above, the compression increases the temperature of the oxygen containing gas (first and second) so that the temperature of the obtained hot compressed oxygen containing gas is higher than the temperature of the oxygen containing gas.

Moreover, offgas, such as compressed offgas, that is subjected to a heat exchanger according to the invention is inevitably heated, whereas the hot compressed oxygen containing gas is cooled. Thus, the temperature of compressed offgas is lower than the temperature of the resulting hot compressed offgas. After the expansion of the hot compressed offgas, a lower compressed and cooler offgas is obtained. The expanded offgas refers to offgas or cold offgas. However, if a multiply stage heat exchange and expansion is used, the pressure reduces successively, and the required heat is supplied successively by the multiply heat exchangers to avoid droplet formation and freezing.

In other words, the temperature of the first and/or second hot compressed offgas can be higher than the temperature of the compressed offgas and offgas, and/or the temperature of the first hot compressed oxygen containing gas and/or second hot compressed oxygen containing gas can be higher than the temperature of the compressed oxygen containing gas.

The temperature of the gases in the specific steps can be as follows; the temperature of the (i) first oxygen containing gas can be 10 to 80° C., preferably 15 to 50° C., more preferably 16 to 30° C., and most preferably 18 to 25° C., (ii) second oxygen containing gas can be 10 to 80° C., preferably 15 to 50° C., more preferably 16 to 30° C., and most preferably 18 to 25° C., (iii) compressed oxygen containing gas, can be 30 to 150° C., preferably 50 to 140° C., more preferably 60 to 130° C., and most preferably 65 to 120° C., (iv) first hot compressed oxygen containing gas can be 90 to 300° C., preferably 120 to 200° C., more preferably 130 to 190° C., and most preferably 140 to 180° C., (v) second hot compressed oxygen containing gas can be 90 to 300° C., preferably 120 to 200° C., more preferably 130 to 190° C., and most preferably 140 to 180° C., (vi) first compressed oxygen containing gas can be 30 to 150° C., preferably 50 to 140° C., more preferably 60 to 130° C., and most preferably 65 to 120° C., (vii) second compressed oxygen containing gas can be 30 to 150° C., preferably 50 to 140° C., more preferably 60 to 130° C., and most preferably 65 to 120° C., (viii) compressed offgas can be 15 to 100° C., preferably 25 to 80° C., more preferably 25 to 70° C., and most preferably 30 to 60° C., (ix) offgas can be 11 to 80° C., preferably 15 to 50° C., more preferably 16 to 30° C., and most preferably 18 to 25° C., (x) first hot compressed offgas can be 60 to 200° C., preferably 70 to 190° C., more preferably 80 to 160° C., and most preferably 110 to 140° C., (xi) second hot compressed offgas can be 60 to 200° C., preferably 70 to 190° C., more preferably 80 to 160° C., and most preferably 110 to 140° C., (xii) first offgas can be 11 to 80° C., preferably 15 to 50° C., more preferably 16 to 30° C., and most preferably 18 to 25° C., and/or (xiii) second offgas can be 11 to 80° C., preferably 15 to 50° C., more preferably 16 to 30° C., and most preferably 18 to 25° C.

The pressure of the gases in the specific steps can be as follows; the pressure of the (i) first oxygen containing gas (126) can be 0.8 to 1.5 bar, preferably 1 bar, more preferably atmospheric pressure, (ii) second oxygen containing gas can be 0.8 to 1.5 bar, preferably 1 bar, more preferably atmospheric pressure, (iii) compressed oxygen containing gas can be 1.5 to 8 bar, preferably 2 to 6 bar, more preferably 3 to 5 bar, and most preferably 3.5 to 5 bar, (iv) first hot compressed oxygen containing gas can be 1.5 to 8 bar, preferably 2 to 7 bar, more preferably 3 to 5 bar, and most preferably 3.5 to 5 bar, (v) second hot compressed oxygen containing gas can be 1.5 to 8 bar, preferably 2 to 7 bar, more preferably 3 to 5 bar, and most preferably 3.5 to 5 bar, (vi) first compressed oxygen containing gas can be 1.5 to 8 bar, preferably 2 to 6 bar, more preferably 3 to 5 bar, and most preferably 3.5 to 5 bar, (vii) second compressed oxygen containing gas can be 1.5 to 8 bar, preferably 2 to 6 bar, more preferably 3 to 5 bar, and most preferably 3.5 to 5 bar, (viii) compressed offgas can be 1.5 to 8 bar, preferably 2 to 6 bar, more preferably 3 to 5 bar, and most preferably 3.5 to 5 bar, (ix) offgas can be 0.8 to 1.5 bar, preferably 1 bar, more preferably atmospheric pressure, (x) first hot compressed offgas can be 1.5 to 8 bar, preferably 2 to 6 bar, more preferably 3 to 5 bar, and most preferably 3.5 to 5 bar, (xi) second hot compressed offgas can be 1.5 to 8 bar, preferably 2 to 6 bar, more preferably 3 to 5 bar, and most preferably 3.5 to 5 bar, (xii) first offgas can be 0.8 to 1.5 bar, preferably 1 bar, more preferably atmospheric pressure, and/or (xiii) second offgas can be 0.8 to 1.5 bar, preferably 1 bar, more preferably atmospheric pressure.

The present invention also concerns a process for making hydrogen peroxide. The process for making hydrogen peroxide can be carried out in a facility or oxidizing unit according to the invention. The process comprises the following steps: (a) hydrogenating a working solution, said working solution comprising an alkylanthraquinone, an alkyltetrahydroanthraquinone or both, contact said working solution with compressed hydrogen in a hydrogenator to provide a hydrogenated working solution comprising an alkylanthrahydroquinone, an alkyltetrahydroanthrahydroquinone or both, (b) oxidizing said hydrogenated working solution obtained in step a) as defined for the process mentioned above to provide an oxidized working solution comprising hydrogen peroxide and an alkylanthraquinone, an alkyltetrahydroanthraquinone or both, (c) extracting hydrogen peroxide from oxidized working solution obtained in step b) to provide an aqueous hydrogen peroxide extract, and (d) concentrating the aqueous hydrogen peroxide extract obtained in step c) in at least one distillation unit comprising an evaporator and a distillation column, said distillation column receiving vapor from said evaporator, to provide a concentrated aqueous hydrogen peroxide solution.

The present invention also relates to an oxidizing unit for oxidizing a hydrogenated working solution, comprising alkylanthrahydroquinone, and/or alkyltetrahydroanthrahydroquinone, in an anthraquinone process for producing hydrogen peroxide. It is preferred that the process for oxidizing a hydrogenated working solution can use the oxidizing unit. Moreover, the oxidizing unit can be used in a process for making hydrogen peroxide as described above. The oxidizing unit comprises the following components: (a) a first compressor for increasing the pressure and the temperature of a first oxygen containing gas, such as air or enriched oxygen containing air, to obtain a first hot compressed oxygen containing gas, such as a first hot compressed air or a first hot compressed enriched oxygen containing air, (b) a first heat exchanger (A) for reducing the temperature of the first hot compressed oxygen containing gas, such as a first hot compressed air or a first hot compressed enriched oxygen containing air, to obtain a first compressed oxygen containing gas, such as a first compressed air or a first compressed enriched oxygen containing air, and (B) for increasing the temperature of compressed offgas to obtain a first hot compressed offgas, (c) an oxidizer for oxidizing a hydrogenated working solution, comprising alkylanthrahydroquinone, and/or alkyltetrahydroanthrahydroquinone with the compressed oxygen containing gas, such as the first compressed oxygen containing gas or the second compressed oxygen containing gas, to thereby obtain an oxidized working solution, comprising hydrogen peroxide and alkylanthraquinone, and/or alkyltetrahydroanthraquinone, and compressed offgas derived from the compressed oxygen containing gas, and (d) a first expander for expanding the first hot compressed offgas provided by the first heat exchanger to obtain a first offgas.

As already mentioned above, the invention can comprise multiply heat exchangers, compressors and expanders. For instance, the oxidizing unit further comprises a second compressor for increasing the pressure and the temperature of the first compressed oxygen containing gas to obtain a second hot compressed oxygen containing gas, such as a second hot compressed air or a second hot compressed enriched oxygen containing air.

Moreover, a second heat exchanger can be present (A) for reducing the temperature of the first compressed oxygen containing gas or the second hot compressed oxygen containing gas to obtain a second compressed oxygen containing gas, such as a second compressed air or a second compressed enriched oxygen containing air, and (B) for increasing the temperature of the first offgas to obtain a second hot compressed offgas. If a second heat exchanger is present, the first expander can be arranged after both heat exchangers so that the compressed offgas is heated successively to the desired temperature, such as 100 to 130° C., and is than expanded in the first expander so that the pressure of the offgas is equal to the atmospheric pressure. Thus, the second heat exchanger is present (B) for increasing the temperature of the compressed offgas after exiting the first heat exchanger (150) to obtain a first hot compressed offgas (154a).

Similarly, a second expander can be present for reducing the temperature and the pressure of the first offgas or the second hot compressed offgas to obtain a second offgas.

A parallel compressor with respect to the first compressor can be arranged in the oxidizing unit so that a second oxygen containing gas can be pressurized. Thus, the parallel compressor can compress a second oxygen containing gas, such as air or enriched oxygen containing air, and thereby increasing the pressure and temperature to obtain a first hot compressed oxygen containing gas, such as a first hot compressed air or a first hot compressed enriched oxygen containing air, wherein the first hot compressed oxygen containing gas obtained from the first and parallel compressor subjected to the first heat exchanger according to item (a)(II) of the oxidizing unit.

The first compressor can comprise multiply stages or multiply compressors, this means that the first compressor is a unit of multiply compressors arranged in series so that the pressure can be increased successively. The same holds true for the parallel compressor. Thus, the first compressor and/or the parallel compressor comprises each at least two compressors that are connected in series so that the pressure increases successively. Preferably a cooling unit is arranged between the compressors arranged in series so that the temperature can be controlled without damaging the compressors.

A filter unit can be arranged in front of the first compressor and/or the parallel compressor so that the first and/or second oxygen containing gas such as air or enriched oxygen containing air, is filtered before being compressed.

As mentioned above, the first expander can drive the first compressor, preferably drives at least one rotating equipment connected with the compressor. Similarly, the second expander can drive the second compressor, preferably drives at least one rotating equipment connected with the second compressor. This results in a significant reduction in energy used for the compression of oxygen containing gas for the AO process.

Furthermore, a bypass conduit for the compressed offgas can be arranged in the oxidation unit so that the compressed offgas can bypass the first heat exchanger and the first expander, and/or the second heat exchanger and the second expander. Another bypass conduit can be arranged in the oxidation unit so that the compressed (hot) oxygen containing gas can bypass the first heat exchanger, the first heat exchanger and the second heat exchanger, or the first heat exchanger, the second heat exchanger and the second compressor. It is possible to control the pressure and the flow with the bypass conduit. The flow can be controlled by valves that are arranged within the bypass conduit.

A heating unit, and/or a filter unit for the offgas can be present in the oxidizing unit. It is desired that the heating unit is arranged before the filter unit and thus, downstream with respect to the filter unit so that the offgas after the expansion is heated. Accordingly, the temperature can be increased after the expansion of the offgas. It is desired that the temperature of the offgas is between 15 and 40° C. so that the activated carbon can sufficiently absorb impurities. The filter unit generally comprises an activated carbon filter.

The oxidizing unit can further comprise a cooling unit for the compressed oxygen containing gas before the compressed oxygen containing gas is supplied to the oxidizer. Thus, said cooling unit is arranged in front of the oxidizer (upstream). Furthermore, a droplet separator can be arranged in front of the oxidizer. Accordingly, the compressed oxygen containing gas can enter a cooling unit and thus a droplet separator before entering the oxidizer.

A cooling unit can be arranged for the compressed offgas after exiting the oxidizer. A chilled water heat exchanger for the compressed offgas can be arranged after the oxidizer and preferably after the aforementioned cooling unit. A first droplet separator for the compressed offgas and/or a second droplet separator for the compressed offgas can be arranged after the first droplet separator. Thus, after the oxidizer the following components for the compressed offgas can be present (from upstream to downstream), a colling unit, a chilled water heat exchanger, a first droplet separator, a second droplet separator for.

The present invention also concerns a facility for producing a concentrated hydrogen peroxide solution by an anthraquinone process. The facility can use a process as mentioned above. The facility comprises (a) a hydrogenator for hydrogenating the working solution, to provide a hydrogenated working solution, (b) an oxidizer, in an oxidizing unit according to the present invention, for oxidizing the hydrogenated working solution with the compressed oxygen containing gas to provide an oxidized working solution comprising hydrogen peroxide, (c) a liquid-liquid extraction column for extracting the oxidized working solution comprising hydrogen peroxide to provide aqueous hydrogen peroxide, and (d) a distillation unit for concentrating the aqueous hydrogen peroxide to provide a concentrated hydrogen peroxide solution.

According to the present invention at least one heat exchanger is used in an anthraquinone process or facility for producing hydrogen peroxide for increasing the temperature of a compressed offgas and for decreasing the temperature of a first and/or second hot compressed oxygen containing gas. Preferably the heat exchanger is used in a process according to the invention. Utilizing said heat exchanger in an AO process avoids the usage of a cooling medium for the hot compressed oxygen containing gas. Moreover, steam is not needed to increase the temperature of the (cold) compressed offgas and the compressed offgas does not form droplets in the expander.

Moreover, at least one expander is used in an anthraquinone process or facility for producing hydrogen peroxide for a first and/or second hot compressed offgas to drive at least one compressor for a first, second oxygen containing gas, and/or a first compressed oxygen containing gas. The energy consumption of a compressor can be significantly reduced in an AO process if heat recovery means are used that are able to drive the compressor. It is desired that at least one expander is an expander turbine, preferably all expanders are expander turbines. Preferably, the expander drives at least one rotating equipment connected with at least one compressor.

The invention will now be described with reference to the accompanying figure which do not limit the scope and ambit of the invention. The description provided is purely by way of example and illustration. However, specific features exemplified in the figures can be used to further restrict the scope of the invention and claims.

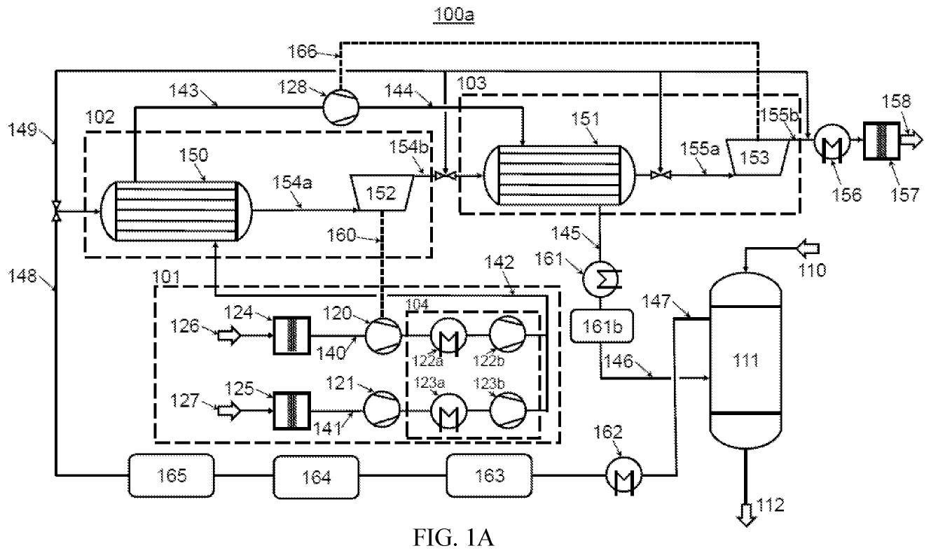

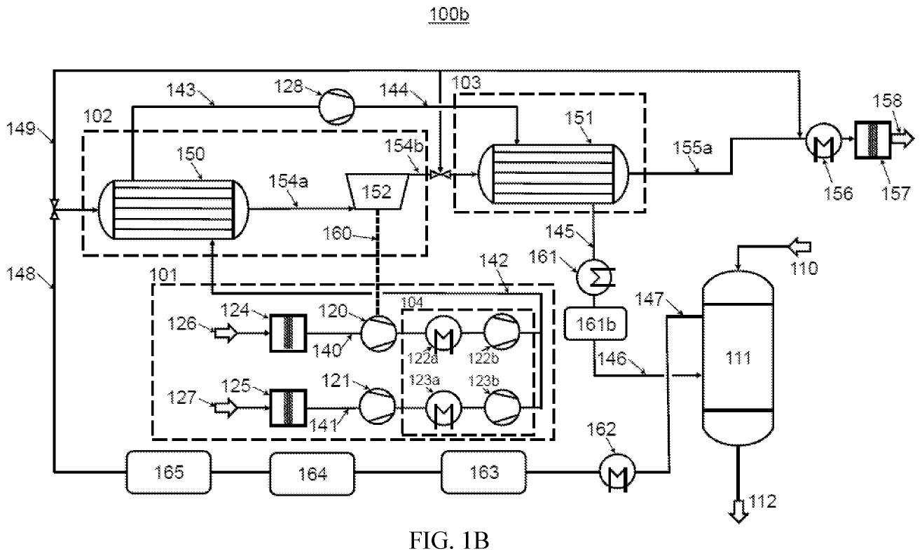

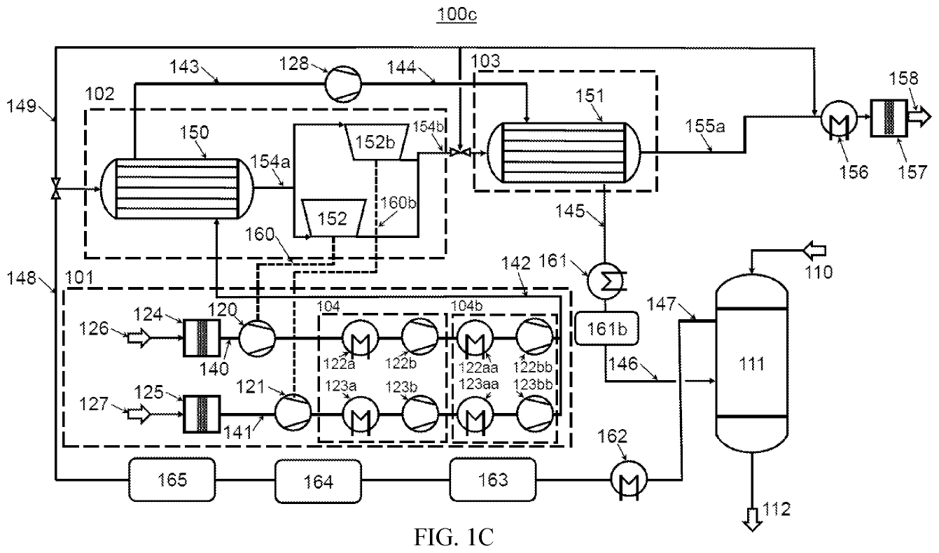

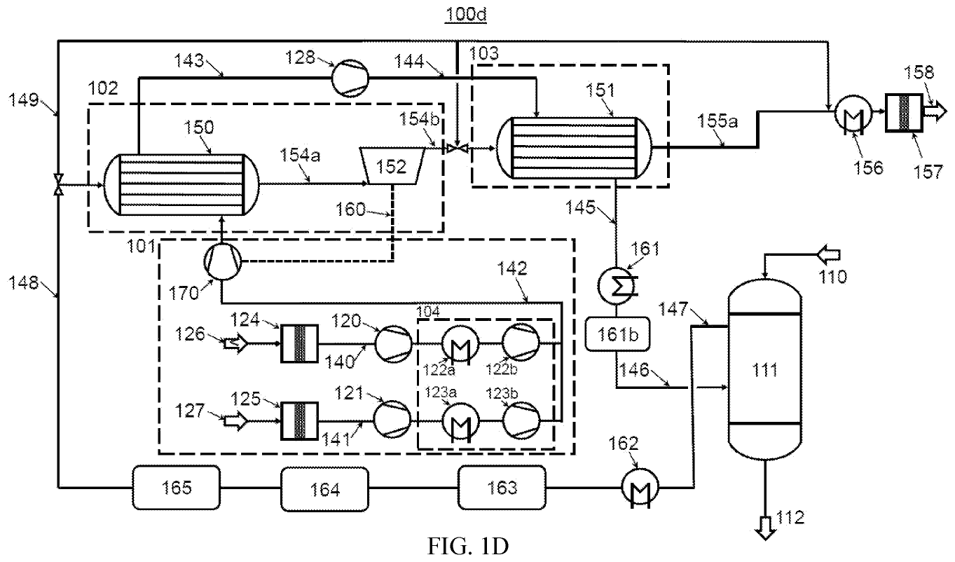

FIG. 1a refers to an oxidizing unit (100a) that can be a part of a facility for the production of hydrogen peroxide. The oxidizing unit comprises an oxidizer (111) for the oxidation of a hydrogenated working solution (110), comprising alkylanthrahydroquinone, and/or alkyltetrahydroanthrahydroquinone to obtain an oxidized working solution (112), comprising hydrogen peroxide and alkylanthraquinone, and/or alkyltetrahydroanthraquinone.

In order to obtain compressed oxygen containing gas, a first oxygen containing gas (126) is compressed in a first compressor (120). It is preferred that the oxygen containing gas used in the present invention is air or oxygen enriched air. A first hot compressed oxygen gas (142) is thereby obtained. It is desirable that the first oxygen containing gas (126) is filtered in a filter unit (124) before being subjected to the first compressor (120). Moreover, a parallel compressor (121) can be used to compress a second oxygen containing gas (127). The second oxygen containing gas (125) should also be filtered in a second filter unit (125) before being subjected to the parallel compressor (121). Both the first compressor (120) as well as the second compressor (121) can comprise multiply compressors that are arranged in series to successively increase the pressure of the oxygen containing gas. In FIG. 1a a second compression stage (122b) (a further compressor) and a second parallel compression stage (123b) (a further compressor) are implemented. Between the first compressor (120) and the second compression stage (122b) a cooling unit (122a) is present so that the temperature after the first compression can be decreased. Similarly, the parallel two stage compressors (121, 123b) also comprise a cooling unit (123a).

The produced first hot compressed oxygen containing gas (142) is then subjected to a first heat exchanger (150) to decrease the temperature of the hot compressed oxygen containing gas (142). The obtained first compressed oxygen containing gas (143) has a lower temperature so that the pressure can be further increased in a second compressor (128) to obtain a second hot compressed oxygen containing gas (144). The second hot compressed oxygen containing gas (144) is then subjected to a second heat exchanger (151) to thereby reduce the temperature to obtain a second compressed oxygen containing gas (145). A further cooling unit for the second compressed oxygen containing gas (161) can be used to adjust the temperature required for the oxidation in the oxidizer (111). It is desirable that the temperature of the compressed oxygen gas (146) that is subjected to the oxidizer is 30 to 60° C., and the pressure is 3.5 to 5 bar. A droplet separator (161b) can be present in front of the oxidizer (111).

After the oxidation, a compressed offgas (147) is obtained. The compressed offgas (147) is first cooled in a cooling unit (162), and subjected to a chilled water heat exchanger (163), a first droplet separator (164) and a second droplet separator (165). It is desired that no droplet formation occurs in the following expanders to avoid malfunctions.

The obtained compressed offgas (148) is then subjected to the first heat exchanger (150) to thereby increase the temperature. It is particularly preferred that the temperature is increase to 60 to 130° C. The pressure of first hot compressed offgas (154a) is reduced in a first expander (152) to obtain a first offgas (154b) that is subjected to a second heat exchanger (151) to increase the temperature, preferably to 60 to 130° C.

The first expander (152) drives (160) the first compressor (120) so that energy is recovered and the compressors consumes less energy. Preferably, the first expander (152) is an expander turbine. The obtained second hot compressed offgas (155a) is then expanded in a second expander (153) so that a second offgas (155b) is obtained. The second expander (153) drives (166) the second compressor (128) so that the second compressor (128) consumes significantly less energy for the compression. The second offgas (155b) should have a low temperature, such as 15 to 60° C., and an ambient pressure, such as 1 bar or atmospheric pressure. The second offgas (155b) can be heated in a heating unit (156) before subjected to a filter unit (157). The heating unit (156) can be subjected with the second compressed oxygen containing gas (145) or, if only one heat exchanger is present in the system first compressed oxygen containing gas (143) or second hot compressed oxygen containing gas (144). The filtered offgas (158) can then release in the environment.

The compressed offgas (148) is able to bypass (149) the first and second heat exchangers (150, 151), and the first and second expanders (152, 153). The temperature at the expander inlet can be controlled by modulating the amount of compressed offgas (148) bypassing the heat exchangers. Control valves in both the offgas line (148) to the expander as well as its bypass line (149) allow individual manipulation of the corresponding flow rates. Ideally, the valve to the expander is fully open, maximizing energy recovery. Pressure fluctuations are compensated by modulating the bypass (149) stream.

FIG. 1b refers to an oxidizing unit (100b) that can be a part of a facility for the production of hydrogen peroxide. In contrast to FIG. 1a, the facility does not comprise a second expander (153).

FIG. 1c refers to an oxidizing unit (100c) that can be a part of a facility for the production of hydrogen peroxide. In contrast to FIG. 1b, the facility comprises a three-stage compression unit (101) and a parallel expander (152b). The parallel expander (152b) drives (160b) the parallel compressor (121) so that energy is recovered and the compressors consumes less energy. Preferably, the parallel expander (152b) is an expander turbine. The compression unit (101) comprises a third compression stage (104b) comprising a second cooling unit (122aa) and third compression stage (122bb) as well as second parallel cooling unit (123aa) and third parallel compression stage (123bb).

FIG. 1d refers to an oxidizing unit (100d) that can be a part of a facility for the production of hydrogen peroxide. In contrast to FIG. 1a, the facility comprises a further compressor (170) for the combined compressed oxygen containing gas (142). Furthermore, the first expander (152) drives (160) the further compressor (170) so that energy is recovered and the compressors consumes less energy. Preferably, the first expander (152) is an expander turbine.

FIG. 2 relates to a process for oxidizing a hydrogenated working solution (200). First, an oxygen containing gas is provided (210) and compressed (211). The temperature of the hot compressed oxygen containing gas is reduced in a heat exchanger (212). The compressed oxygen containing gas is then used for the oxidation (213) of a hydrogenated working solution. The compressed offgas is heated (214) in the heat exchanger and then expanded (215) to obtain an offgas that can be released (216) in the environment. Accordingly, FIG. 2 reveals an oxidizing unit that comprises a first compressor (120), a first heat exchanger (150), an oxidizer (111) and a first expander (152).

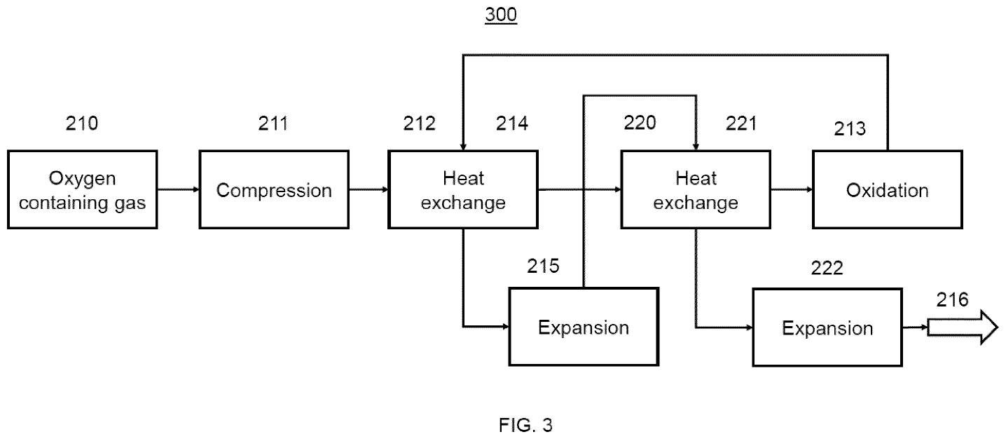

FIG. 3 also relates to a process for oxidizing a hydrogenated working solution (300). However, the process (300) additionally (with respect to the process mentioned in FIG. 2) comprises a second heat exchanger (151) and a second expander (153). Accordingly, the hot compressed oxygen containing gas and the compressed offgas is subjected to the first heat exchanger (212, 214) and to the second heat exchanger (220, 221) to successively decrease/increase the temperature. Moreover, the compressed offgas is additionally subjected to a second expander (222) and then the offgas can be released (216) in the environment. Alternatively, it is also possible that the compressed offgas is subjected to only one expander (222) after subjecting to the two heat exchangers (214, 221).

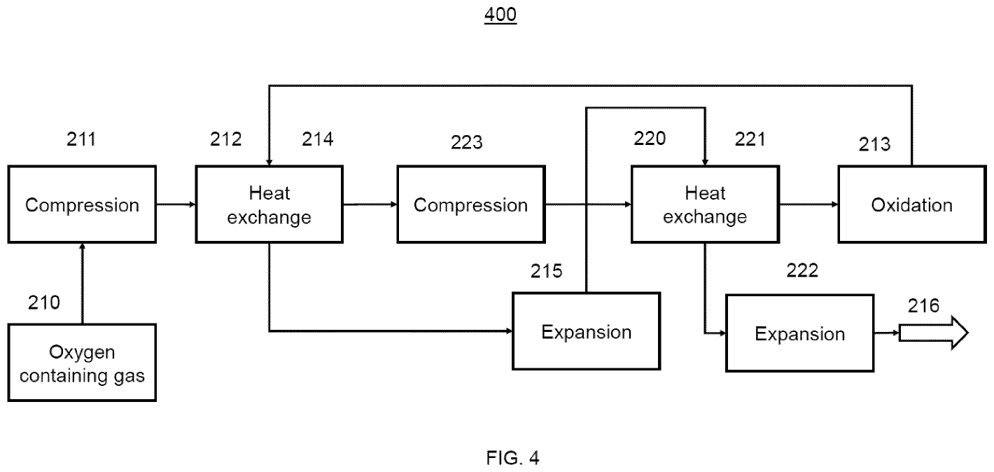

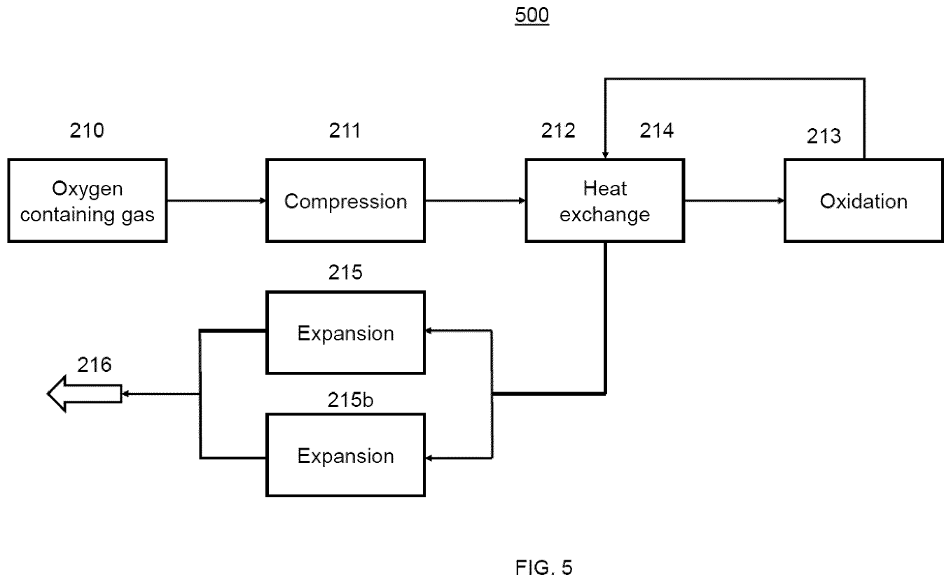

FIG. 4 relates to a process for oxidizing a hydrogenated working solution (400) and compared to FIG. 3, comprises two compressors. A second compressor (223) is arranged between the first and second heat exchangers (212, 220).

FIG. 5 relates to a process for oxidizing a hydrogenated working solution (200). First, an oxygen containing gas is provided (210) and compressed (211). The temperature of the hot compressed oxygen containing gas is reduced in a heat exchanger (212). The compressed oxygen containing gas is then used for the oxidation (213) of a hydrogenated working solution. The compressed offgas is heated (214) in the heat exchanger and then expanded (215) in parallel (215b) using two expanders to obtain an offgas that can be released (216) in the environment. Accordingly, FIG. 5 reveals an oxidizing unit that comprises a first compressor (120), a first heat exchanger (150), an oxidizer (111) and a first expander (152) and a parallel expander (152b).

### EXAMPLES

### Example 1

In an AO facility according to the prior art, the compressed (cold) offgas (145,000 kg/h flow) is heated using steam consuming 5.7 t/h of steam. At 145,500 kg/h offgas flow, heating the compressed offgas from 30° C. to 120° C. consumes 3800 kW. Moreover, a cooling tower is used to reduce the temperature of the hot compressed oxygen containing gas.

In the AO facility according to the invention, the hot compressed oxygen containing gas was utilized to heat the compressed (cold) offgas from 30° C. to 120° C. using a heat exchanger instead of steam. The obtained hot compressed offgas could be subjected to an expander to provide offgas without freezing or droplet formation in the expander. The offgas after expansion is fed with a temperature of not more than 35° C. to the activated carbon towers so that the performance of the activated carbon could be increased.

Accordingly, utilizing the hot compressed oxygen containing gas to heat the compressed (cold) offgas avoids the usage of 5.7 t/h of steam. Moreover, no additional cooling medium is required to reduce the temperature of the compressed oxygen containing gas for the oxidizing step. Finally, the hydrogen peroxide production is not negatively affected.

### Example 2

In the AO facility according to the invention (see Example 1), an expander was installed for reducing the pressure of the compressed offgas, the expander drives the compressor for increasing the pressure and temperature of the oxygen containing gas. As a benefit, the compressors' power uptake of 10.4 MW or 350 kWh/t % could be reduced by 3.25 MW to 240 kWh/t %.

### LIST OF REFERENCE SIGNS

100a-d Oxidizing units
101 Compression unit
102 First expander unit
103 Second expander unit
104 Second compression stage
104b Third compression stage
110 Hydrogenated working solution
111 Oxidizer
112 Oxidized working solution
120 First compressor
121 Parallel compressor
122a First cooling unit
122aa Second cooling unit
122b Second compression stage
122bb Third compression stage
123a First parallel cooling unit
123aa Second parallel cooling unit
123b Second parallel compression stage
123bb Third parallel compression stage
124 First filter unit
125 Second filter unit
126 First oxygen containing gas
127 Second oxygen containing gas
128 Second compressor
140 Filtered first oxygen containing gas
141 Filtered second oxygen containing gas
142 First hot compressed oxygen containing gas
143 First compressed oxygen containing gas
144 Second hot compressed oxygen containing gas
145 Second compressed oxygen containing gas
146 Compressed oxygen containing gas
147 Compressed offgas after exiting the oxidizer
148 Compressed offgas
149 Bypassing offgas
150 First heat exchanger
151 Second heat exchanger
152 First expander
152b First parallel expander
153 Second expander
154a First hot compressed offgas
154b First offgas
155a Second hot compressed offgas
155b Second offgas
156 Heating unit for the offgas
157 Filter unit for the offgas
158 Filtered offgas
160 Rotating equipment for the first compressor
160b Rotating equipment for the parallel compressor
161 Cooling unit for the compressed oxygen containing gas
161b Droplet separator
162 Cooling unit for the compressed offgas
163 Chilled water heat exchanger
164 First droplet separator
165 Second droplet separator
166 Rotating equipment for the second compressor
170 Further compressor
200 Process for oxidizing a hydrogenated working solution
210 Providing the first oxygen containing gas
211 Compressing the first oxygen containing gas
212 Reducing the temperature of the first hot compressed oxygen containing gas
213 Oxidizing with the compressed oxygen containing gas
214 Increasing the temperature of the compressed offgas
215 Expanding the first hot compressed offgas
215 Parallel expanding the first hot compressed offgas
216 Providing offgas
220 Reducing the temperature of the second hot compressed oxygen containing gas
221 Increasing the temperature of the first offgas
222 Expanding the second hot compressed offgas
223 Compressing the first compressed oxygen containing gas
300 Process for oxidizing a hydrogenated working solution comprising two heat exchangers and two expanders
400 Process for oxidizing a hydrogenated working solution comprising two heat exchangers, two expanders, and two compressors

It will be appreciated that various modifications can be made, and that many changes can be made in the preferred embodiments without departing from the principle of the invention. The present invention is further described by the following aspects.

### Aspects of the Invention

1. A process (200) for oxidizing a hydrogenated working solution (110), comprising alkylanthrahydroquinone, and/or alkyltetrahydroanthrahydroquinone, in an anthraquinone process for producing hydrogen peroxide, preferably carried out in an oxidizing unit (100a-d) as defined in any one of aspects 18 to 31, or a facility as defined in aspect 32, comprising the steps:
   (a) providing a compressed oxygen containing gas (143, 145, 146) obtained after the following steps, preferably the compressed oxygen containing gas (143, 145, 146) is the first, second compressed oxygen containing gas (143, 145, 146), or the second hot compressed oxygen containing gas (144), comprising:
      (I) compressing (211) a first oxygen containing gas (126), such as air or enriched oxygen containing air, in a first compressor (120) and thereby increasing the pressure and temperature to obtain a first hot compressed oxygen containing gas (142), such as a first hot compressed air or a first hot compressed enriched oxygen containing air, and
      (II) subjecting (212) the first hot compressed oxygen containing gas (142) obtained in step (a)(I) to a first heat exchanger (150), to thereby reduce the temperature to obtain a first compressed oxygen containing gas (143), such as a first compressed air or a first compressed enriched oxygen containing air,
   (b) oxidizing (213) a hydrogenated working solution (110), comprising alkylanthrahydroquinone, and alkyltetrahydroanthrahydroquinone, with the compressed oxygen containing gas (143, 145, 146) obtained in step (a) to thereby obtain an oxidized working solution (112), comprising hydrogen peroxide and alkylanthraquinone, and/or alkyltetrahydroanthraquinone, and compressed offgas (148) derived from the compressed oxygen containing gas (143, 145, 146), and
   (c) providing (216) offgas (154b, 155b) obtained after the following steps, preferably the offgas (154b, 155b) is the first, or second offgas (154b, 155b), comprising:
      (I) subjecting (214) the compressed offgas (148) obtained in step (b) to the heat exchanger (150) mentioned in step (a)(II), that is subjected with the first hot compressed oxygen containing gas (142), to thereby obtain a first hot compressed offgas (154a), and
      (II) expanding (215) the first hot compressed offgas (154a) in a first expander (152) and thereby reducing the pressure and temperature to obtain a first offgas (154b).
2. The process according to aspect 1, wherein step (a) further includes a step (II) after step (II), compressing (223) the first compressed oxygen containing gas (143) obtained in step (a)(II) in a second compressor (128), and thereby increasing the pressure and temperature to obtain a second hot compressed oxygen containing gas (144), such as a second hot compressed air or a second hot compressed enriched oxygen containing air.
3. The process according to aspects 1 or 2, wherein
   (A) step (a) further includes a step (IV) after step (II) and optionally after step (II), subjecting (210) the first compressed oxygen containing gas (143), obtained in step (a)(II), or the second hot compressed oxygen containing gas (144) obtained in step (a)(II) to a second heat exchanger (151), to thereby reduce the temperature to obtain a second compressed oxygen containing gas (145), such as a second compressed air or a second compressed enriched oxygen containing air, and
   (B) wherein step (c) further includes step (II) after step (II), subjecting (221) the first offgas (154b) obtained in step (c)(II) to the second heat exchanger (151) mentioned in step (a)(IV), to thereby obtain a second hot compressed offgas (155a),
4. The process according to any one of the preceding aspects, wherein step (c) further includes a step (IV) after step (II) and optionally after step (II) or before step (I), expanding (222) the first offgas (154b) obtained in step (c)(II), or the second hot compressed offgas (155a) obtained in step (c)(II), in a second expander (153) and thereby reducing the pressure and temperature to obtain a second offgas (155b).
5. The process according to any one of the preceding aspects, wherein the step (a)(I) further includes compressing a second oxygen containing gas (127), such as air or enriched oxygen containing air, in a parallel compressor (121) and thereby increasing the pressure and temperature to obtain a first hot compressed oxygen containing gas (142), such as a first hot compressed air or a first hot compressed enriched oxygen containing air, wherein the first hot compressed oxygen containing gas (142) obtained from the first and parallel compressor (120, 121) is subjected to the first heat exchanger (150) according to step (a)(II).
6. The process according to any one of the preceding aspects, wherein the first compressor (120) and/or the parallel compressor (121) comprises each at least two compressors that are connected in series (120, 122b and 121, 123b) so that the pressure increases successively, preferably a cooling unit (122a, 123a) is arranged between the compressors arranged in series (120, 122b and 121, 123b).
7. The process according to any one of the preceding aspects, wherein a filter unit (124, 127) is arranged in front of the first compressor (120) and/or the second compressor (128) so that the first and/or second oxygen containing gas (126, 127), such as air or enriched oxygen containing air, is filtered before the compression.
8. The process according to any one of the preceding aspects, wherein the first expander (152) drives the first compressor (120), preferably drives at least one rotating equipment (160) connected with the compressor (120).
9. The process according to any one of the preceding aspects, wherein the second expander (153) drives the second compressor (128), preferably drives at least one rotating equipment (166) connected with the second compressor (128).
10. The process according to any one of the preceding aspects, wherein a portion, such as 1 to 60%, preferably 5 to 40%, more preferably 10 to 30%, and most preferably 15 to 30% bypasses the first heat exchanger (150) as well as the first expander (152) and preferably bypasses the first heat exchanger (150), the first expander (152), the second heat exchanger (151) and the second expander (153).
11. The process according to any one of the preceding aspects, wherein the process further comprises step:
   (d) heating the offgas (154b, 155b) in a heating unit (156), and/or
   (e) filtering the offgas (154b, 155b) in a filter unit (157), preferably the filter unit (157) comprises an activated carbon filter.
12. The process according to any one of the preceding aspects, wherein the compressed oxygen containing gas (143, 145, 146) obtained in step (a) is cooled in a cooling unit (161) before used for oxidation according to step (b).
13. The process according to any one of the preceding aspects, wherein the compressed offgas (147) obtained in step (b) is cooled in a cooling unit (162).
14. The process according to any one of the preceding aspects, wherein the compressed offgas (147) obtained in step (b):
   (A) is subjected to a chilled water heat exchanger (163),
   (B) is subjected to a first droplet separator (164), and/or
   (C) is subjected to a second droplet separator (165).
15. The process according to any one of the preceding aspects, wherein the temperature of the first and/or second hot compressed offgas (154a, 155a) is higher than the temperature of the compressed offgas (147, 148) and offgas (154), and/or wherein the temperature of the first hot compressed oxygen containing gas (142) and/or second hot compressed oxygen containing gas (144) is higher than the temperature of the compressed oxygen containing gas (145).
16. The process according to any one of the preceding aspects, wherein the temperature of the
   (i) first oxygen containing gas (126) is 10 to 80° C., preferably 15 to 50° C., more preferably 16 to 30° C., and most preferably 18 to 25° C.,
   (ii) second oxygen containing gas (127) is 10 to 80° C., preferably 15 to 50° C., more preferably 16 to 30° C., and most preferably 18 to 25° C.,
   (iii) compressed oxygen containing gas (143, 145, 146), is 30 to 150° C., preferably 50 to 140° C., more preferably 60 to 130° C., and most preferably 65 to 120° C.,
   (iv) first hot compressed oxygen containing gas (142) is 90 to 300° C., preferably 120 to 200° C., more preferably 130 to 190° C., and most preferably 140 to 180° C.,
   (v) second hot compressed oxygen containing gas (144) is 90 to 300° C., preferably 120 to 200° C., more preferably 130 to 190° C., and most preferably 140 to 180° C.,
   (vi) first compressed oxygen containing gas (143) is 30 to 150° C., preferably 50 to 140° C., more preferably 60 to 130° C., and most preferably 65 to 120° C.,
   (vii) second compressed oxygen containing gas (145) is 30 to 150° C., preferably 50 to 140° C., more preferably 60 to 130° C., and most preferably 65 to 120° C.,
   (viii) compressed offgas (147, 148) is 15 to 100° C., preferably 25 to 80° C., more preferably 25 to 70° C., and most preferably 30 to 60° C.,
   (ix) offgas (154) is 11 to 80° C., preferably 15 to 50° C., more preferably 16 to 30° C., and most preferably 18 to 25° C.,
   (x) first hot compressed offgas (154a) is 60 to 200° C., preferably 70 to 190° C., more preferably 80 to 160° C., and most preferably 110 to 140° C.,
   (xi) second hot compressed offgas (155a) is 60 to 200° C., preferably 70 to 190° C., more preferably 80 to 160° C., and most preferably 110 to 140° C.,
   (xii) first offgas (154b) is 11 to 80° C., preferably 15 to 50° C., more preferably 16 to 30° C., and most preferably 18 to 25° C., and/or
   (xiii) second offgas (155b) is 11 to 80° C., preferably 15 to 50° C., more preferably 16 to 30° C., and most preferably 18 to 25° C.
17. The process according to any one of the preceding aspects, wherein the pressure of the
   (i) first oxygen containing gas (126) is 0.8 to 1.5 bar, preferably 1 bar, more preferably atmospheric pressure,
   (ii) second oxygen containing gas (127) is 0.8 to 1.5 bar, preferably 1 bar, more preferably atmospheric pressure,
   (iii) compressed oxygen containing gas (143, 145, 146) is 1.5 to 8 bar, preferably 2 to 6 bar, more preferably 3 to 5 bar, and most preferably 3.5 to 5 bar,
   (iv) first hot compressed oxygen containing gas (142) is 1.5 to 8 bar, preferably 2 to 7 bar, more preferably 3 to 5 bar, and most preferably 3.5 to 5 bar,
   (v) second hot compressed oxygen containing gas (144) is 1.5 to 8 bar, preferably 2 to 7 bar, more preferably 3 to 5 bar, and most preferably 3.5 to 5 bar,
   (vi) first compressed oxygen containing gas (143) is 1.5 to 8 bar, preferably 2 to 7 bar, more preferably 3 to 5 bar, and most preferably 3.5 to 5 bar,
   (vii) second compressed oxygen containing gas (145) is 1.5 to 8 bar, preferably 2 to 7 bar, more preferably 3 to 5 bar, and most preferably 3.5 to 5 bar,
   (viii) compressed offgas (147, 148) is 1.5 to 8 bar, preferably 2 to 6 bar, more preferably 3 to 5 bar, and most preferably 3.5 to 5 bar,
   (ix) offgas (154) is 0.8 to 1.5 bar, preferably 1 bar, more preferably atmospheric pressure,
   (x) first hot compressed offgas (154a) is 1.5 to 8 bar, preferably 2 to 6 bar, more preferably 3 to 5 bar, and most preferably 3.5 to 5 bar,
   (xi) second hot compressed offgas (155a) is 1.5 to 8 bar, preferably 2 to 6 bar, more preferably 3 to 5 bar, and most preferably 3.5 to 5 bar,
   (xii) first offgas (154b) is 0.8 to 1.5 bar, preferably 1 bar, more preferably atmospheric pressure, and/or
   (xiii) second offgas (155b) is 0.8 to 1.5 bar, preferably 1 bar, more preferably atmospheric pressure.
18. A process for making hydrogen peroxide, particularly carried out in a facility according to aspect 32, preferably using the oxidizing unit (100a-d) according to aspects 19 to 31, comprising the steps:
   (a) hydrogenating a working solution, said working solution comprising an alkylanthraquinone, an alkyltetrahydroanthraquinone or both, contact said working solution with compressed hydrogen in a hydrogenator to provide a hydrogenated working solution comprising an alkylanthrahydroquinone, an alkyltetrahydroanthrahydroquinone or both,
   (b) oxidizing said hydrogenated working solution obtained in step a) as defined in any one of the preceding aspects to provide an oxidized working solution comprising hydrogen peroxide and an alkylanthraquinone, an alkyltetrahydroanthraquinone or both,
   (c) extracting hydrogen peroxide from oxidized working solution obtained in step b) to provide an aqueous hydrogen peroxide extract, and
   (d) concentrating the aqueous hydrogen peroxide extract obtained in step c) in at least one distillation unit comprising an evaporator and a distillation column, said distillation column receiving vapor from said evaporator, to provide a concentrated aqueous hydrogen peroxide solution.
19. An oxidizing unit (100a-d) for oxidizing a hydrogenated working solution (110), comprising alkylanthrahydroquinone, and/or alkyltetrahydroanthrahydroquinone, in an anthraquinone process for producing hydrogen peroxide, preferably using the process as defined in any one of the preceding aspects, comprising:
   (a) a first compressor (120) for increasing the pressure and the temperature of a first oxygen containing gas (126), such as air or enriched oxygen containing air, to obtain a first hot compressed oxygen containing gas (142), such as a first hot compressed air or a first hot compressed enriched oxygen containing air,
   (b) a first heat exchanger (150) (A) for reducing the temperature of the first hot compressed oxygen containing gas (142), such as a first hot compressed air or a first hot compressed enriched oxygen containing air, to obtain a first compressed oxygen containing gas (143), such as a first compressed air or a first compressed enriched oxygen containing air, and (B) for increasing the temperature of compressed offgas (148) to obtain a first hot compressed offgas (154a),
   (c) an oxidizer (111) for oxidizing a hydrogenated working solution (110), comprising alkylanthrahydroquinone, and/or alkyltetrahydroanthrahydroquinone with the compressed oxygen containing gas (143, 145, 146), such as the first compressed oxygen containing gas (143) or the second compressed oxygen containing gas (145), to thereby obtain an oxidized working solution (112), comprising hydrogen peroxide and alkylanthraquinone, and/or alkyltetrahydroanthraquinone, and compressed offgas (148) derived from the compressed oxygen containing gas (143, 145, 146), and
   (d) a first expander (152) for expanding the first hot compressed offgas (154a) provided by the first heat exchanger (150) to obtain a first offgas (154b).
20. The oxidizing unit (100a-d) according to aspect 19, further comprising a second compressor (128) for increasing the pressure and the temperature of the first compressed oxygen containing gas (143) to obtain a second hot compressed oxygen containing gas (144), such as a second hot compressed air or a second hot compressed enriched oxygen containing air.
21. The oxidizing unit (100a-d) according to aspects 19 or 20, further comprising a second heat exchanger (151) (A) for reducing the temperature of the first compressed oxygen containing gas (143) or the second hot compressed oxygen containing gas (144) to obtain a second compressed oxygen containing gas (145), such as a second compressed air or a second compressed enriched oxygen containing air, and (B) for increasing the temperature of the first offgas (154b) to obtain a second hot compressed offgas (155a), or for increasing the temperature of the compressed offgas after exiting the first heat exchanger (150) to obtain a first hot compressed offgas (154a).
22. The oxidizing unit (100a-d) according to any one of aspects 19 to 21, further comprising a second expander (153) for reducing the temperature and the pressure of the first offgas (154b) or the second hot compressed offgas (155a) to obtain a second offgas (155b).
23. The oxidizing unit (100a-d) according to any one of aspects 19 to 22, a parallel compressor (121) to compress a second oxygen containing gas (127), such as air or enriched oxygen containing air, and thereby increasing the pressure and temperature to obtain a first hot compressed oxygen containing gas (142), such as a first hot compressed air or a first hot compressed enriched oxygen containing air, wherein the first hot compressed oxygen containing gas (142) obtained from the first and parallel compressor (120, 121) is subjected to the first heat exchanger (150) according to item (a)(II).
24. The oxidizing unit (100a-d) according to any one of aspects 19 to 23, wherein the first compressor (120) and/or the parallel compressor (121) comprises each at least two compressors that are connected in series (120, 122b and 121, 123b) so that the pressure increases successively, preferably a cooling unit (122a, 123a) is arranged between the compressors arranged in series (120, 122b and 121, 123b).
25. The oxidizing unit (100a-d) according to any one of aspects 19 to 24, wherein a filter unit (124, 125) is arranged in front of the first compressor (120) and/or the parallel compressor (121) so that the first and/or second oxygen containing gas (126, 127), such as air or enriched oxygen containing air, is filtered before being compressed.
26. The oxidizing unit (100a-d) according to any one of aspects 19 to 25, wherein the first expander (152) drives the first compressor (120), preferably drives at least one rotating equipment (160) connected with the compressor (120).
27. The oxidizing unit (100a-d) according to any one of aspects 19 to 26, wherein the second expander (153) drives the second compressor (128), preferably drives at least one rotating equipment (166) connected with the second compressor (120).
28. The oxidizing unit (100a-d) according to any one of aspects 19 to 27, further comprising a bypass conduit (149) for the compressed offgas (148) so that the compressed offgas (148) can bypass the first heat exchanger (150) and the first expander (152), and/or the second heat exchanger (151) and the second expander (153).
29. The oxidizing unit (100a-d) according to any one of aspects 19 to 28, further comprising a heating unit (156), and/or a filter unit (157), preferably the filter unit (157) comprises an activated carbon filter, for the offgas (154b, 155b).
30. The oxidizing unit (100a-d) according to any one of aspects 19 to 29, further comprises a cooling unit (161) for the compressed oxygen containing gas (143, 145, 146) before supplied to the oxidizer (111).
31. The oxidizing unit (100a-d) according to any one of aspects 19 to 30, further comprising:
   (A) a chilled water heat exchanger (163) for the compressed offgas (147),
   (B) a first droplet separator (164) for the compressed offgas (147), and/or
   (C) a second droplet separator (165) for the compressed offgas (147).
32. A facility for producing a concentrated hydrogen peroxide solution by an anthraquinone process, preferably using a process according to aspects 1 to 18, comprising:
   (a) a hydrogenator for hydrogenating the working solution, to provide a hydrogenated working solution,
   (b) an oxidizer (111), in an oxidizing unit (100a-d) as defined in aspects 18 to
31, for oxidizing the hydrogenated working solution with the compressed oxygen containing gas (143, 145, 146) to provide an oxidized working solution (112) comprising hydrogen peroxide,
   (c) a liquid-liquid extraction column for extracting the oxidized working solution comprising hydrogen peroxide to provide aqueous hydrogen peroxide, and
   (d) a distillation unit for concentrating the aqueous hydrogen peroxide to provide a concentrated hydrogen peroxide solution.
33. Use of at least one heat exchanger (150, 151) in an anthraquinone process or facility for producing hydrogen peroxide for increasing the temperature of a compressed offgas (148) and for decreasing the temperature of a first and/or second hot compressed oxygen containing gas (142, 144), preferably in a process as defined in aspects 1 to 17.
34. Use of at least one expander (152, 153) for a first and/or second hot compressed offgas (154a, 155a) to drive at least one compressor (120, 128) for a first, second oxygen containing gas (126, 127), and/or a first compressed oxygen containing gas (143), preferably drives at least one rotating equipment (160) connected with at least one compressor (120, 128).
35. The use according to aspect 34, wherein the at least one expander used for a first and/or second hot compressed offgas (154a, 155a) is an expander turbine.

1. A process for oxidizing a hydrogenated working solution comprising alkylanthrahvdroquinone, and/or alkyltetrabydroanthrahydroquinone, in an anthraquinone process for producing hydrogen peroxide, the process, comprising:
(a) providing a compressed oxygen containing gas obtained after:
(I) compressing a first oxygen containing gas, in a first compressor and thereby increasing a pressure and a temperature of the first oxygen containing gas to obtain a first hot compressed oxygen containing gas, and
(II) subjecting the first hot compressed oxygen containing gas obtained in (a)(I) to a first heat exchanger, to thereby reduce a temperature of the first hot compressed oxygen containing gas and to obtain a first compressed oxygen containing gas,
(b) oxidizing a hydrogenated working solution,
comprising alkylanthrahydroquinone, and alkyltetrahydroanthrahydroquinone, with the compressed oxygen containing gas obtained in (a) to thereby obtain an oxidized working solution comprising hydrogen peroxide, alkylanthraquinone and/or alkyltetraydroanthraquinone, and a compressed offgas derived from the compressed oxygen containing gas, and
(c) providing an offgas obtained after:
(I) subjecting the compressed offgas obtained in (b) to the first heat exchanger mentioned in (a)(II), that is subjected with the first hot compressed oxygen containing gas, to thereby obtain a first hot compressed offgas, and
(II) expanding the first hot compressed offgas in a first expander and thereby reducing a pressure and a temperature of the first hot compressed offgas to obtain a first offgas.

2. The process according to claim 1, wherein (a) further includes (III) after (II), (a)(III) comprising:
compressing the first compressed oxygen containing gas obtained in (a)(II) in a second compressor, and thereby increasing a pressure and a temperature of the first compressed oxygen containing gas to obtain a second hot compressed oxygen containing gas.

3. The process according to claim 2, wherein
(a) further includes (TV) after (II) and optionally after (III), (a)(V) comprising subjecting the first compressed oxygen containing gas obtained in (a)(II), or the second hot compressed oxygen containing gas obtained in (a)(III) to a second heat exchanger, to thereby reduce the temperature of the first compressed oxygen containing gas or a temperature of the second hot compressed oxygen containing gas to obtain a second compressed oxygen containing gas, and
wherein (c) further includes (III) after (II), (c)(III) comprising subjecting the first offgas obtained in (c)(II) to the second heat exchanger mentioned in (a)(IV), to thereby obtain a second hot compressed offgas.

4. The process according to claim 3, wherein (c) further includes (IV) after (II) and optionally after (III) or before (I), (c)(IV) comprising expanding the first offgas obtained in (c)(II), or the second hot compressed offgas obtained in (c)(III), in a second expander and thereby reducing a pressure and temperature of the first offgas or the second hot compressed offgas to obtain a second offgas.

5. The process according to claim 1, wherein (a)(I) further includes compressing a second oxygen containing gas in a parallel compressor and thereby increasing a pressure and a temperature of the second oxygen containing gas to obtain the first hot compressed oxygen containing gas, wherein the first hot compressed oxygen containing gas obtained from the first compressor and the parallel compressor is subjected to the first heat exchanger according to (a)(II).

6. The process according to claim 1, wherein the first expander drives the first compressor, and/or wherein a second expander drives a second compressor.

7. A process for making hydrogen peroxide, the process comprising:
(a) hydrogenating a working solution, said working solution comprising an alkylanthraquinone, an alkyltetrahydroanthraqluinone or both, and contacting said working solution with compressed hydrogen in a hydrogenator to provide a hydrogenated working solution comprising an alkylanthrahydroquinone, an alkyltetrahydroanthrahydroquinone or both,
(b) oxidizing said hydrogenated working solution obtained in a) to provide an oxidized working solution comprising hydrogen peroxide and an alkylanthraquinone, an alkyltetrahydroanthraquinone, or both, the process for oxidizing the hydrogenated working solution, comprising
(I) providing a compressed oxygen containing gas obtained after:
1. compressing a first oxygen containing gas, in a first compressor and thereby increasing a pressure and a temperature of the first oxygen containing gas to obtain a first hot compressed oxygen containing gas, and
2. subjecting the first hot compressed oxygen containing gas obtained in (b)(1)(1) to a first heat exchanger, to thereby reduce a temperature of the first hot compressed oxygen containing gas and to obtain a first compressed oxygen containing gas,
(II) oxidizing the hydrogenated working solution, comprising alkylanthrahydroquinone, and alkyltetrahydroanthrahydroquinone, with the first compressed oxygen containing gas obtained in (b)(I)(2) to thereby obtain an oxidized working solution comprising hydrogen peroxide and alkylanthraquinone, and/or alkyltetrahydroanthraquinone, and a compressed offgas derived from the compressed oxygen containing gas, and
(III) providing an offgas obtained after:
1. subjecting the compressed offgas obtained in (II) to the first heat exchanger mentioned in (b)(I)(2) that is subjected with the first hot compressed oxygen containing gas, to thereby obtain a first hot compressed offgas, and
2. expanding the first hot compressed offgas in a first expander and thereby reducing a pressure and a temperature of the first hot compressed offgas to obtain a first offgas.
(c) extracting hydrogen peroxide from the oxidized working solution obtained in b) to provide an aqueous hydrogen peroxide extract, and
(d) concentrating the aqueous hydrogen peroxide extract obtained in c) in at least one distillation unit comprising an evaporator and a distillation column, said distillation column receiving vapor from said evaporator, to provide a concentrated aqueous hydrogen peroxide solution.

8. An oxidizing unit for oxidizing a hydrogenated working solution, comprising alkylanthrahydroquinone and/or alkyltetrahydroanthrahydroquinone, in an anthraquinone process for producing hydrogen peroxide, the oxidizing unit comprising:
(a) a first compressor for increasing a pressure and a temperature of a first oxygen containing gas to obtain a first hot compressed oxygen containing gas,
(b) a first heat exchanger (A) for reducing a temperature of the first hot compressed oxygen containing gas to obtain a first compressed oxygen containing gas and (B) for increasing a temperature of a compressed offgas derived from a compressed oxygen containing gas to obtain a first hot compressed offgas,
(c) an oxidizer for oxidizing a hydrogenated working solution comprising alkylanthrahydroquinone and/or alkyltetrahydroanthrahydroquinone with the compressed oxygen containing gas or a second compressed oxygen containing gas, to thereby obtain an oxidized working solution comprising hydrogen peroxide and alkylanthraquinone and/or alkyltetrahydroanthraquinone, and the compressed offgas derived from the compressed oxygen containing gas, and
(d) a first expander for expanding the first hot compressed offgas provided by the first heat exchanger to obtain a first offgas.

9. The oxidizing unit according to claim 8, further comprising a second compressor for increasing a pressure and a temperature of the first compressed oxygen containing gas to obtain a second hot compressed oxygen containing gas.

10. The oxidizing unit according to claim 9, further comprising a second heat exchanger
(A) for reducing the temperature of the first compressed oxygen containing gas or a temperature of the second hot compressed oxygen containing gas to obtain the second compressed oxygen containing gas, and
(B) for increasing a temperature of the first offgas to obtain a second hot compressed offgas, or for increasing the temperature of the compressed offgas after exiting the first heat exchanger to obtain the first hot compressed offgas.

11. The oxidizing unit according to claim 10, further comprising a second expander for reducing the temperature and a pressure of the first offgas or a temperature and a pressure of the second hot compressed offgas to obtain a second offgas.

12. The oxidizing unit according to claim 11, wherein the first expander drives the first compressor and/or wherein the second expander drives the second compressor.

13. A facility for producing a concentrated hydrogen peroxide solution by an anthraquinone process, the facility comprising:
(a) a hydrogenator for hydrogenating a working solution, to provide a hydrogenated working solution,
(b) an oxidizer, in the oxidizing unit as defined in claim 8, for oxidizing the hydrogenated working solution with the compressed oxygen containing gas to provide an oxidized working solution comprising hydrogen peroxide,
(c) a liquid-liquid extraction column for extracting the oxidized working solution comprising hydrogen peroxide to provide aqueous hydrogen peroxide, and
(d) a distillation unit for concentrating the aqueous hydrogen peroxide to provide a concentrated hydrogen peroxide solution.

14. A method for increasing a temperature of a compressed offgas derived from a compressed oxygen containing gas, and for decreasing a temperature of a first and/or second hot compressed oxygen containing gas, the method comprising:
subjecting the compressed offgas to at least one heat exchanger in an anthraquinone process or facility for producing hydrogen peroxide.

15. A method, comprising:
driving at least one compressor with at least one expander for a first and/or second oxygen containing gas and/or a first compressed oxygen containing gas in an anthraquinone process or facility for producing hydrogen peroxide for a first and/or second hot compressed offgas.

16. The process according to claim 1, wherein the first oxygen containing gas is air or enriched oxygen containing air, and
wherein the first hot compressed oxygen containing gas is a first hot compressed air or a first hot compressed enriched oxygen containing air, and
wherein the first compressed oxygen containing gas is a first compressed air or a first compressed enriched oxygen containing air.

17. The process according to claim 2, wherein the second hot compressed oxygen containing gas is a second hot compressed air or a second hot compressed enriched oxygen containing air.

18. The process according to claim 3, wherein the second compressed oxygen containing gas is a second compressed air or a second compressed enriched oxygen containing air.

19. The process according to claim 5, wherein the second oxygen containing gas is air or enriched oxygen containing air.

20. The process according to claim 1, wherein the first expander drives at least one rotating equipment connected with the first compressor, and/or wherein the second expander drives at least one rotating equipment connected with the second compressor.
